(19) United States
(12) Patent Application Publication
(10) Pub. No.: US 2006/0260196 A1
(43) Pub. Date: Nov. 23, 2006

(54) EYEHOLE APPARATUS AND DOOR WITH THE EYEHOLE APPARATUS

(76) Inventor: Lai- Fu Cheng, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,650

(22) Filed: Sep. 18, 2005

(30) Foreign Application Priority Data
May 17, 2005 (TW) 94115862

(51) Int. Cl. E06B 7/28

(52) U.S. Cl. 49/171

(57) ABSTRACT

An eyehole apparatus and a door with the eyehole apparatus are disclosed. The eyehole device is installed in the peephole of the door. The eyehole device includes an image capture device built in the peephole of the door. When someone rings the door bell or the user in the house activates the eyehole apparatus, the image capture device captures views outside the door for displaying on a flat panel display device. In addition, a storage device is included for recording current views or searching previously recorded views to constantly monitoring the conditions outside the door.

### CROSS-REFERENCE TO RELATED APPLICATION

This application claims the priority benefit of Taiwan application serial no. 94115862, filed on May 17, 2005. All disclosure of the Taiwan application is incorporated herein by reference.

### BACKGROUND OF THE INVENTION

1. Field of Invention

The present invention relates to a door with eyehole apparatus, and more particularly to a door, which can capture a picture outside the door for displaying on a flat panel display device and storage of such a picture for viewing.

2. Description of Related Art

Nowadays eyehole is usually installed in the doors of average households or rooms of hotels to prevent strangers with bad intention from intruding when opening the door. However, said eyehole is conventionally a convex lens with narrow angle view of outside the door and user's eyes must be positioned right against the eyehole for view outside the door.

FIG. 1 is a conventional door including: a door panel 100 for dividing the exit and the entrance; a door lock 110, suitable for preventing the door panel 100 from being opened by visitors outside the door; an eyehole 120, disposed in the upper middle edge of the door panel 100, which magnifies view outside the door through a convex lens; and, a bolt 130 and a bolt 140 for fixing the door panel 100.

However, the eyehole is usually installed at certain height. When there is only a child in the house and someone pushes the door bell, the child have to open the door to see visitor outside the door and the stranger may intrude the house. Moreover, the eyehole merely functions as viewer and users are unable to record clear view of suspicious characters outside the door, but only rely on their memory.

### SUMMARY OF THE INVENTION

Accordingly, the present invention is directed to provide a door with eyehole apparatus. An image capture device is installed in the peephole of the door to capture a picture outside the door automatically for displaying on a plane display device, so that it achieves the purpose of monitoring the conditions outside the door.

An aspect of the present invention is to provide an eyehole apparatus. The eyehole device is installed in a door. The eyehole device can display a picture outside the door on a flat panel display device, and record current views or search previously recorded views to constantly monitor conditions outside the door.

The present invention provides an eyehole apparatus, including: an image capture device, built in the peephole of the door to automatically capture views outside the door; a flat panel display device for displaying the image by the image capture device; and a base for fixing the image capture device and the flat panel display device on the door panel.

The door with the eyehole apparatus according to one embodiment of the present invention further includes a storage device for recording the images by the image capture device.

For the door with the eyehole apparatus according to one embodiment of the present invention, the storage device is a memory card slot, suitable for inserting a memory card, or a memory kit to access and transfer pictures.

The door with the eyehole apparatus according to one embodiment of the present invention further includes a plurality of screw holes for bolting a plurality of screws to fix the base on the door panel.

For the door with the eyehole apparatus according to one embodiment of the present invention, the image capture device is a charge coupled device (CCD) or a complementary metal-oxide semiconductor (CMOS) image display device.

For the door with the eyehole apparatus according to one embodiment of the present invention, the plane display device is a liquid crystal display (LCD) or an organic light emitting diode (OLED).

The present invention provides a door with an eyehole apparatus, and the eyehole apparatus is installed in the peephole of the door. The door includes: a door panel for dividing the exit and the entrance; an image capture device, built in the peephole of the door to automatically capture views outside the door; a flat panel display device for displaying the image captured by the image capture device; and a base for fixing the image capture device and the flat panel display device on the door panel.

The door with the eyehole apparatus according to one embodiment of the present invention further includes a door bell, coupled to the eyehole apparatus. When someone rings the door bell, views outside the door is displayed on the flat panel display device.

The present invention uses an image capture device, built in in the peephole of the door panel, for capturing views outside the door and displaying on a flat panel display device. Additionally, a storage device is included for recording current views or searching previously recorded images and constantly monitoring the conditions outside the door.

To achieve aforementioned and other objectives, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional door device.

FIG. 2 is a front view of a door with an eyehole apparatus according to one embodiment of the present invention.

FIG. 3 is a side view of a door with an eyehole apparatus according to one embodiment of the present invention.

### DESCRIPTION OF EMBODIMENTS

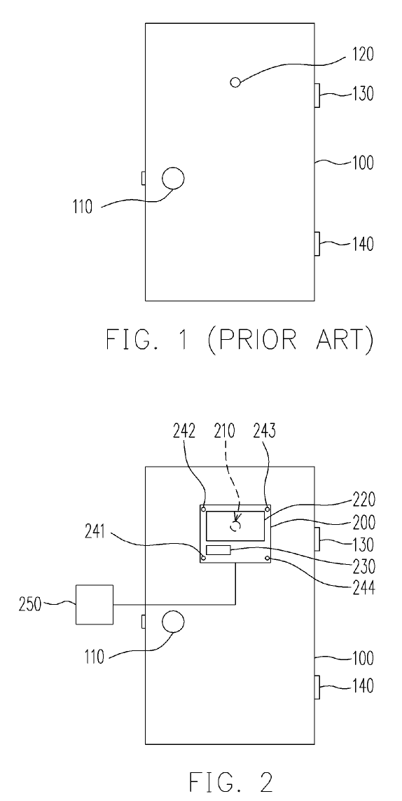

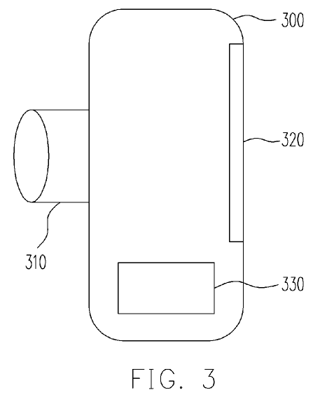

FIG. 2 is a front view of a door with a eyehole apparatus according to one embodiment of the present invention, wherein the door panel 100, the door lock 110, the door bolts 130 and 140 have the same functions as those in FIG. 1. Accordingly, related description is omitted herein. Please refer to FIG. 1 and FIG. 2 together, in the embodiment, an eyehole apparatus 200 is disposed in the peephole 120 as shown in FIG. 1; the image capture device 210 is disposed inside the eyehole of the peephole 120; the flat panel display device 220 is connected with the image capture device 210 to display views outside the door captured by the image capture device 210. In addition, the eyehole apparatus 200 further includes a storage device 230 for recording the views outside the door captured by the image capture device 210, wherein the storage device may be a memory card slot for user to insert a memory card to record data, or a built-in memory, for users to access or transfer pictures through an interface. However, the storage device is merely one embodiment of the present invention, and the present invention is not limited by this; therefore, users can use other storage devices as required without departing from the scope or spirit of the invention.

The eyehole apparatus 200 also includes four screw holes 241, 242, 243, 244, used to fix the eyehole apparatus 200 on the door panel by screws. In this embodiment, four screw holes in the eyehole apparatus 200 are provide. However, the type and the quantity of the skew holes are not limited to by this embodiment. Users can use other means to fix the eyehole apparatus 200 as required.

Moreover, the eyehole apparatus 200 of the embodiment further connects to a door bell 250. When someone ring the door bell 250, the image capture device 210 is activated to capture views outside the door for displaying on a flat panel display device 220.

FIG. 3 is a side view of a door 300 with an eyehole apparatus according to one embodiment of the present invention, including an image capture device 310, a plane display device 320, and a storage device 330.

In addition, the image capture device in the embodiment of the present invention includes a charge coupled device (CCD) or a complementary metal-oxide semiconductor (CMOS) image display device. However, the present invention does not limit its scope, and users can use other types of image capture device and flat panel display device as required without departing from the scope or spirit of the invention.

In summary, for the door with the eyehole apparatus of the present invention, an image capture device is disposed in the peephole of the door. When someone rings the doorbell or the user in the house activates the eyehole apparatus, the image capture device captures views outside the door for displaying on a flat panel display device. In addition, a storage device is included to provide for recording current views or searching previsouly recorded images to constantly monitoring the conditions outside the door.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An eyehole apparatus, including:
an image capture device, built in the peephole of the door to capture a picture outside the door;
a flat panel display device for displaying the image captured by the image capture device; and
a base, suitable for fixing the image capture device and the flat panel display device on the door panel.

2. The eyehole apparatus as claimed in claim 1, further includes a storage device, suitable for recording the images by the image capture device.

3. The eyehole apparatus as claimed in claim 2, wherein the storage device is a memory card slot, suitable for inserting a memory card.

4. The eyehole apparatus as claimed in claim 2, wherein the storage device is a memory.

5. The eyehole apparatus as claimed in claim 1, wherein the base further includes a plurality of screw holes for bolting a plurality of bolts to fix the base on the door panel.

6. The eyehole apparatus as claimed in claim 1, wherein the image capture device is a charge coupled device (CCD).

7. The eyehole apparatus as claimed in claim 1, wherein the image capture device is a complementary metal-oxide semiconductor (CMOS) image display device.

8. The eyehole apparatus as claimed in claim 1, wherein the flat panel display device is a liquid crystal display (LCD).

9. The eyehole apparatus as claimed in claim 1, wherein the flat panel display device is an organic light emitting diode (OLED).

10. A door with a eyehole apparatus, suitable for installing the eyehole apparatus in the peephole of the door, including:
a door panel, for dividing the exit and the entrance of the building;
an image capture device, built in the peephole of the door to capture views outside the door;
a flat panel display device, for displaying the images captured by the image capture device; and
a base, for fixing the image capture device and the flat panel display device on the door panel.

11. The eyehole apparatus as claimed in claim 10, further includes:
a storage device, for recording the images captured by the image capture device.

12. The eyehole apparatus as claimed in claim 10, further includes:
a door bell, coupled to the eyehole apparatus, when someone rings the bell, views outside the door is displayed on the flat panel display device.
